(19) United States
(12) Patent Application Publication
(10) Pub. No.: US 2003/0015355 A1
(43) Pub. Date: Jan. 23, 2003

(54) Method for modifying handwriting locus of handwriting-input device

(76) Inventors: Chi-Ti Kao, Yung-Ho City (TW); Cheng-Tang Su, Hsinchu City (TW)

Correspondence Address: SUPREME PATENT SERVICES, POST OFFICE BOX 2339, SARATOGA, CA, 95070, US

(21) Appl. No.: 09/909,048

(22) Filed: Jul. 18, 2001

(51) Int. Cl. G06K 11/06; G08C 21/00

(52) U.S. Cl. 178/18.01

(57) ABSTRACT

A method for modifying handwriting locus of a handwriting-input device comprises a locus processing procedure for receiving the output original induction coordinates of a communication interface between the operating system and the handwriting-input device. By taking advantage of a weight-based plotting method for adjusting the original induction coordinates of the handwriting-input device and loading the same to an application program, a smoother handwriting locus is obtainable.

### FIELD OF THE INVENTION

This invention relates generally to a method for input and display of plots of an electronic machine, more particularly, it relates to a method for modifying handwriting locus of a handwriting-input device.

### BACKGROUND OF THE INVENTION

Application of the handwriting-input technology seems matured day after day for input of graphics or letters.

As indicated in an operation flowchart shown in FIG. 1, the operation of a generic handwriting-input device may be divided into three layers, namely, a hardware-device layer 110, an operating-system layer 120, and an application-program layer 130, wherein a handwriting-input device 111 (a handwriting tablet, a mouse, etc.) of the hardware-device layer 110 is employed to sense a user's input action and create induced coordinates to be transmitted to the operating system 120 and processed by a driver 121 in that layer and a communication interface 122 between the operating system and the handwriting-input device, then relayed to an application program 131 in the application-program layer 130 for output or applications otherwise.

However, in application of a handwriting-input device, a series of discrete induction points created by hardware is rather coarse and the handwriting locus plotted by the application programs is somewhat unsmooth and stiff (see the embodiment shown in FIG. 8(A)).

For improvements of abovesaid defects, this invention is intended to provide a method for modifying handwriting locus of handwriting-input device so as to smoothen the curve connecting those discrete induction points and heighten the fidelity of the handwriting graphics or letters.

### SUMMARY OF THE INVENTION

The primary object of this invention is to provide a method for modifying locus data and thereby a handwriting locus can be smoothened.

In order to realize abovesaid object, this invention is elaborated to provide a method for modifying handwriting locus of a handwriting-input device. The method comprises a locus processing procedure for receiving the output original induction coordinates of a communication interface between the operating system and the handwriting-input device. By taking advantage of a weight-based plotting method for adjusting the original induction coordinates of the handwriting-input device and loading the same to an application program, a smoother handwriting locus is obtainable.

For more detailed information regarding advantages or features of this invention, at least an example of preferred embodiment will be elucidated below with reference to the annexed drawings.

### BRIEF DESCRIPTION OF THE DRAWINGS

The related drawings in connection with the detailed description of this invention to be made later are described briefly as follows, in which:

FIG. 1 shows an operational flowchart of a conventional handwriting-input device;

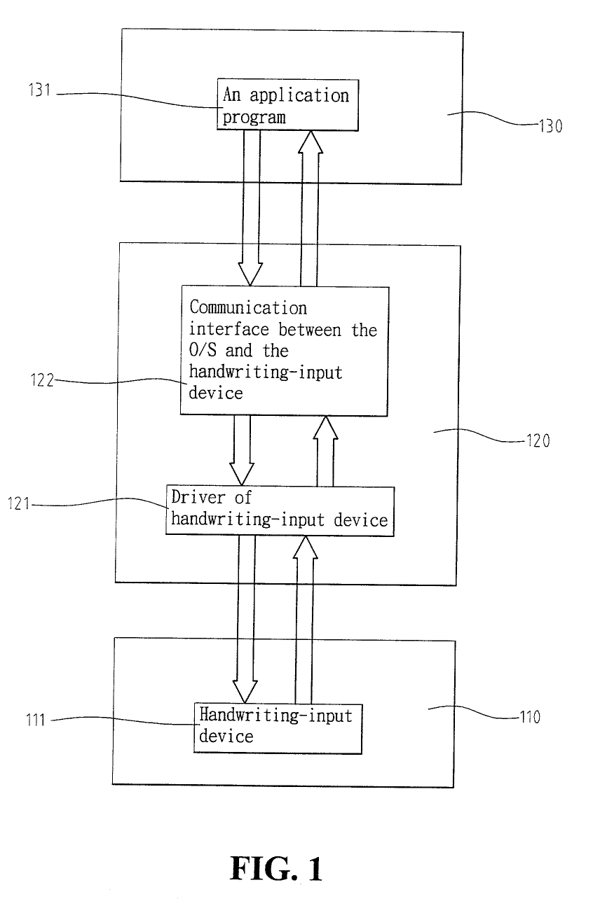

FIG. 2 shows an operational flowchart of a handwriting-input device of this invention;

FIG. 3 shows the flowchart of a locus processing procedure;

FIG. 4 shows a plotted locus formed by returned original induction coordinate data from the handwriting-input device of this invention;

FIG. 5 shows a locus curve plotted by substituting returned coordinate data in FIG. 4 by way of treating every triple points a set in the Bezier curve function;

FIG. 6 shows some new points of inflection obtained by a weight-based plotting method;

FIG. 7 shows a locus curve plotted by substituting new coordinate data of FIG. 4 obtained by the weight-based plotting method in the Bezier curve function;

FIG. 8A shows a plotted locus made by connecting the output original induction coordinates of the handwriting-input device with straight-line segments;

FIG. 8B shows a plotted locus made by way of treating triple points of the output original induction coordinates of the handwriting-input device a set to form a Bezier curve; and

FIG. 8C shows a plotted locus made on basis of the output original induction coordinates of the handwriting-input device by way of obtaining new points of inflection with the weight-based plotting method, then forming a Bezier curve by connecting triple points.

### DETAILED DESCRIPTION OF THE INVENTION

A conventional handwriting-input device is implemented for input of a user's handwriting graphics or letters, which are formatted in discrete induction coordinates and expressed in a serrate locus by the system application programs.

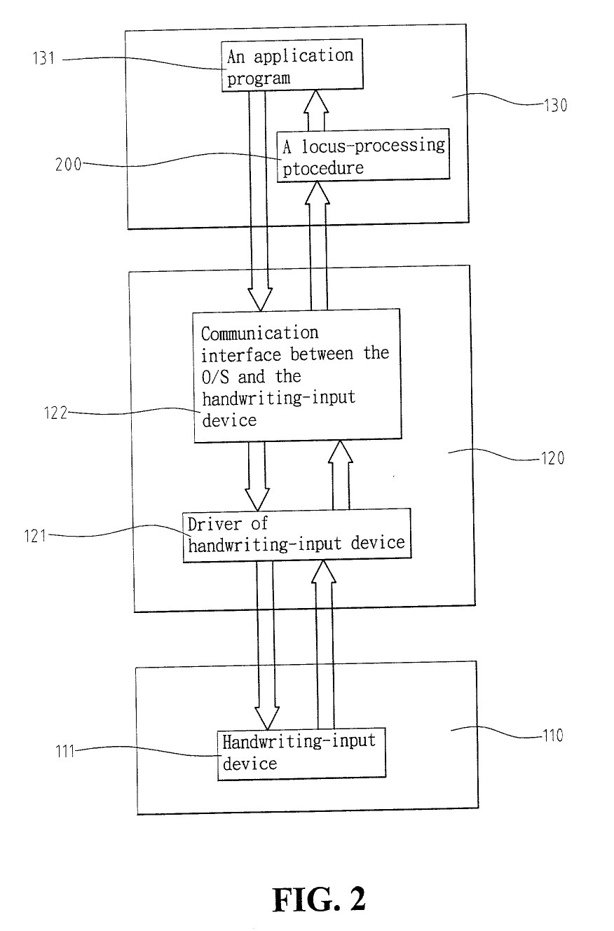

As shown in FIG. 2—an operational flowchart of a handwriting-input device of this invention—a locus processing procedure 200 is offered in an application-program layer 130 for adjusting the output original coordinate data released from a communication interface 122 between the operating system and the handwriting-input device, then loading an application program 131 to create a smooth locus.

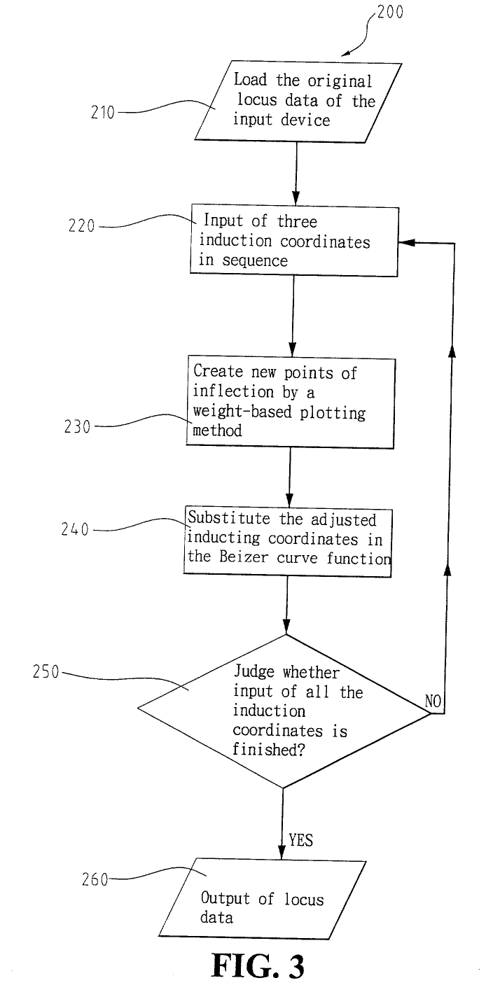

Referring to FIG. 3—a flowchart of the locus processing procedure—the original induction coordinate data produced in the handwriting-input device are loaded to the locus processing procedure 200 through the communication interface 122, and after processing from step 210 all the way down to step 260, the coordinate data are transferred to the application programs for reproducing the handwriting locus smoothly, wherein the step 210 is to load the original moving locus of the input device; step 220 is arranged for input of triple-point induction coordinates sequentially for proceeding subsequent steps to create smooth locus; step 230 is to use a weight-based plotting method for generating coordinates of new points of inflection; step 240 is to substitute the adjusted locus data in the Bezier curve function for producing smooth line segments, wherein the Bezier curve function is applied to create a line segment by substituting triple-point coordinates for connection of respective induction coordinates.

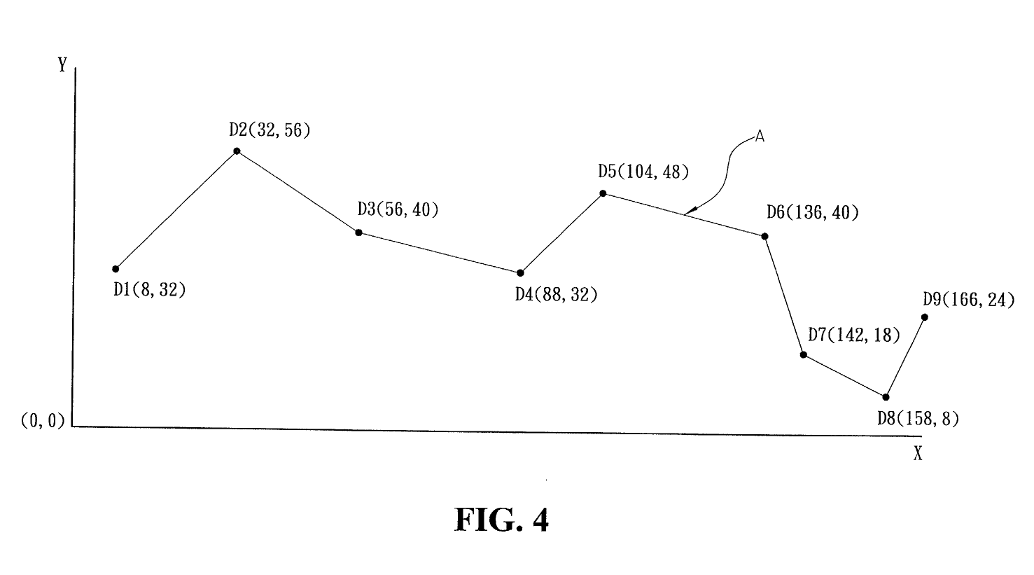

In an embodiment shown in FIG. 4, the returned original induction coordinate data from the handwriting-input device include 9 Cartesian points, namely, D1(8, 32), D2(32, 56), D3(56, 40), D4(88, 32), D5(104, 48), D6(136, 40), D7(142, 16), D8(158, 8), D9(166, 24). When all the Cartesian points, from D1 through D9, are connected together by straight-line segments, a serrate locus (A) is formed.

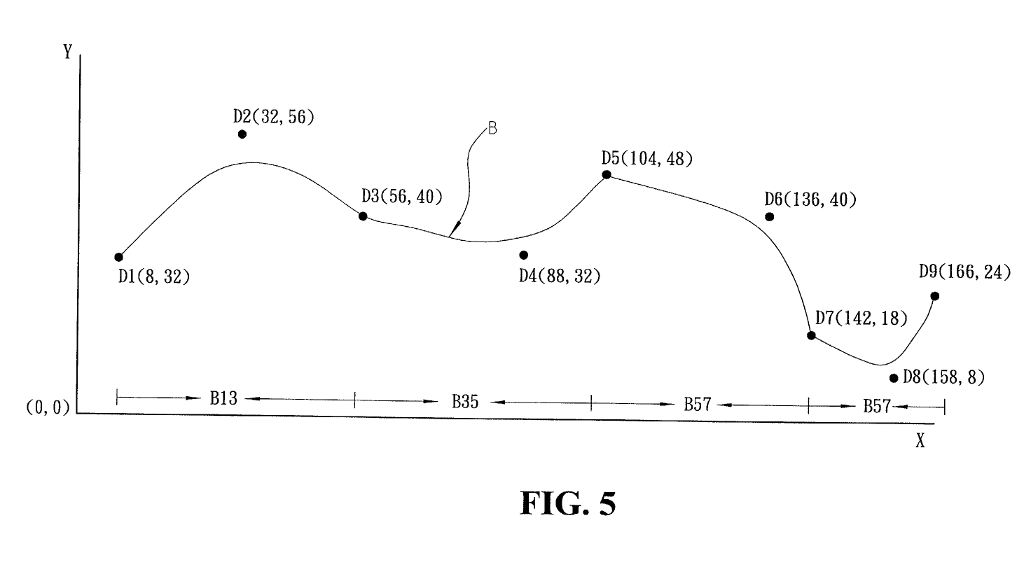

If the coordinate data of every triple-points from D1 through D9 are substituted in the Beizer curve function, a locus (B) is formed shown in FIG. 5, including curve segment B13(D1˜D3), B35(D3˜D5), B57(D5˜D7), B79(D7˜D9). The locus (B) in FIG. 5 is obviously smoother than the locus (A) in FIG. 4, nevertheless, there are unnatural inflections found at the intersection D3, D5, and D7. When looking into this matter, the slope in a curve segment is changed gradually, namely, the slope at a start end of the curve segment is turned bit by bit into that of a terminal end. If now the terminal end of this curve segment becomes a start end of a next segment, the slope at the present segment is affected by the next segment and inflected abruptly. Hence, for avoiding a sudden change of the slope and an abrupt inflection accordingly, it's possible to find out a new point of inflection located at an intersection between a midpoint of the present and the next curve segments so that the slope can be changed slowly and smoothly. Moreover, the new point of inflection is taken as a terminal end of the present curve segment and a start end of the next curve segment for smoothing the intersection of those two segments, and it's the reason why the step 230 is adopted to obtain the weight ratio of the midpoint of those segments by using the weight-based plotting method to calculate the new points of inflection. The equation of the weight-based plotting method is shown below:

E(X, Y)=W1*M1(X, Y)+W2*M2(X, Y)

W1+W2=1,

wherein M1 and M2 are midpoints of two contiguous curve segments respectively; E is a new point of inflection; W1 and W2 are respective weights provided to M1 and M2; and 0<both W1 and W2<1. The position of the new point of inflection E can be controlled by adjusting the value of W1 and W2, that is, E tends to approach M1 if W1>W2, or E tends to approach M2 if W1<W2.

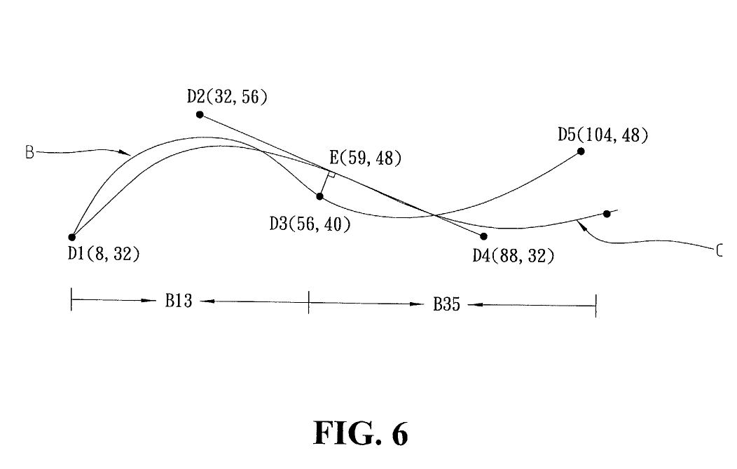

When value of W1 and W2 can satisfy the condition that the distance between the new and the original point of inflection is the closest, the value of W1 and W2 are considered the best weight values capable of forming the smoothest locus shown in FIG. 6.

Taking the curve segment B13 and B35 an example for calculation of weight value, the locus (B) is inflected at the intersection D3 (56, 40). Since the foregoing equation of the weigh-based plotting method is linear, therefore, different new points of inflection E substituted in the Beizer curve function will be found locating on different straight-line segments between the Cartesian point D2 and D4. For rendering the point of inflection E as closer as possible to the original induction locus, adjustment of the value of W1 and W2 is required in order to obtain the best weight value that can make the distance between a new point of inflection E and Cartesian position D3 the shortest. In this example, the coordinates of the Cartesian point D3 projected on the straight-line segment between the Cartesian point D2 and D4 are 59 and 48—the coordinates of a new point of inflection E—where W1=0.49 and W2=0.51.

The step 240 is to substitute the data of the new point of inflection E obtained by the step 230 in the Beizer curve function for creating a smooth locus (C). Step 250 is supposed to judge whether input of all the given induction coordinate data is finished, if positive, the procedure enters the step 260 for output of the adjusted locus data to an application program, otherwise, goes to the step 220 to continue processing of the original induction coordinates in the manner of treating every triple points a set.

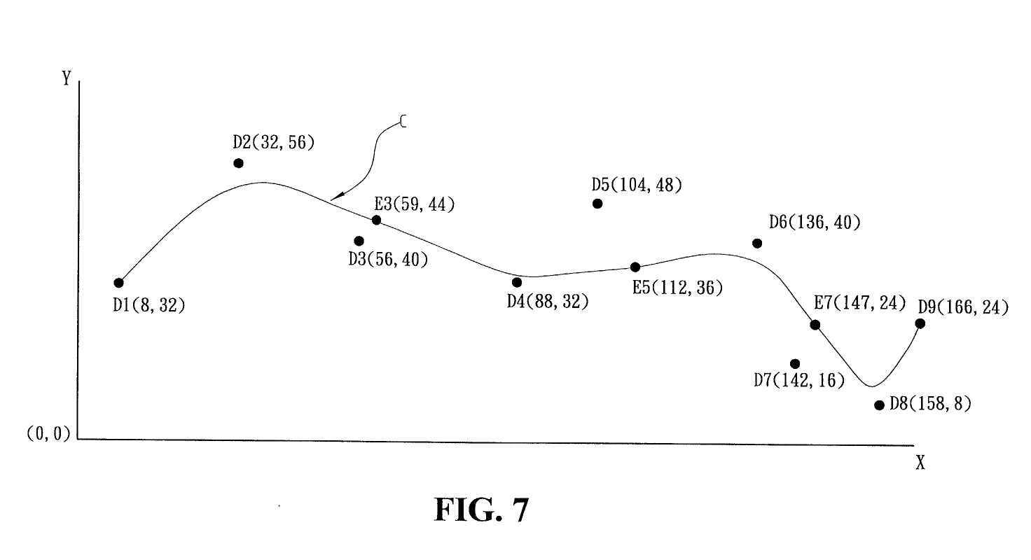

FIG. 7 shows that the returned coordinates of Cartesian points from the handwriting-input device in FIG. 4 are treated with the weight-based plotting method and new points of inflection are obtained and substituted in the Beizer curve function to have the locus (C) plotted, which is obviously smoother than the locus (A) or the locus (B). In the locus (C), E3(59, 44), E5(112, 36), and E7(147, 24) are new points of inflection calculated by the weight-based plotting method and substituted for the Cartesian point D3(56, 40), D5(104, 48), and D7(142, 16). Thus, the preferred locus (C) is obtained by substituting the value of D1, D2, E3, D4, E5, D6, E7, D8, and D9 in the Beizer curve function.

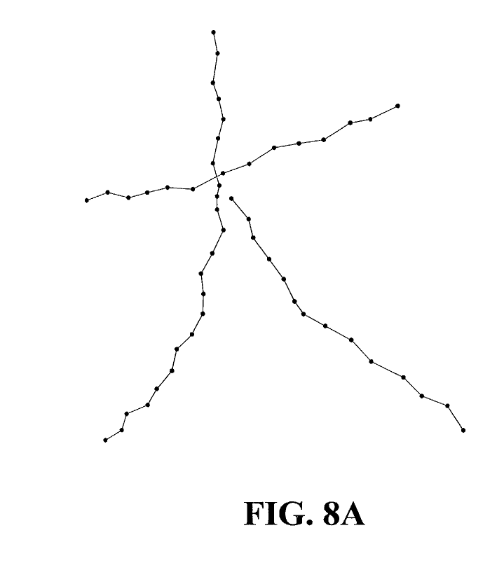

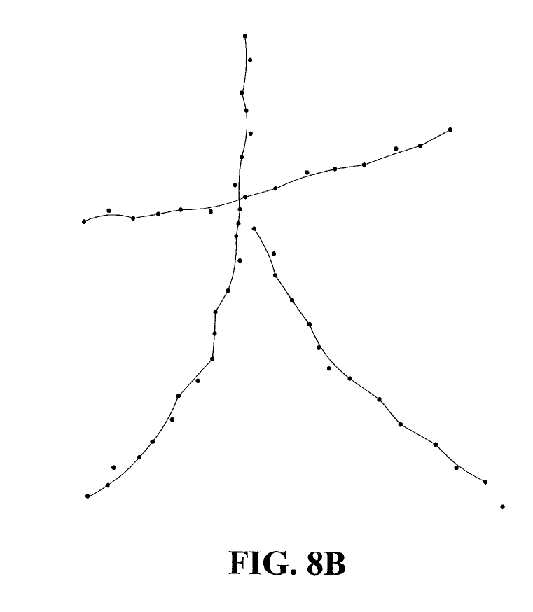

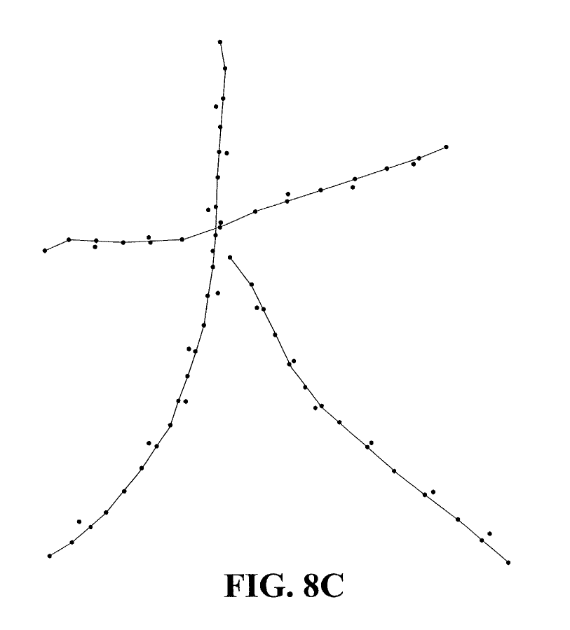

FIG. 8A through FIG. 8C show different loci of original induction Cartesian points of the handwriting-input device treated in different extents, wherein the original induction Cartesian points in FIG. 8A are connected directly with straight-line segments; that in FIG. 8B produce a Beizer curve in the manner of treating every triple points a set; and that in FIG. 8C are taken as a base and treated with the weight-based plotting method to obtain new points of inflection to substitute for original points of inflection, then applied to produce a Beizer curve in the manner of treating every triple points a set.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A method for modifying handwriting locus of handwriting-input device, wherein the method comprises a locus-processing procedure for treating with data of original induction Cartesian points of a handwriting-input device so that an application program is implemented to plot a smooth handwriting locus according to values obtained basing on the treated data of the original induction Cartesian points.

2. The method according to claim 1, wherein the locus-processing procedure is provided to use a weight-based plotting method for adjusting the original coordinate data and weighting the midpoint of two contiguous straight-line segments to thereby obtain a new point of inflection, which is then substituted in the Beizer curve function to plot a smoother locus.

3. The method according to claim 2, wherein the equation of the weight-based plotting method is:
E(X, Y)=W1*M1(X, Y)+W2*M2(X, Y)
W1+W2=1,
wherein M1 and M2 are midpoints of two contiguous curve segments respectively; E is a new point of inflection; W1 and W2 are respective weights provided to M1 and M2; 0<both W1 and W2<1; and an original Cartesian point is an original point of inflection, a terminal end of the present curve segment, and a start end of a next curve segment.

4. The method according to claim 3, wherein the new point of inflection E is a projection point of the original point of inflection on a curve segment connecting M1 and M2, and the corresponding weight value thereof is the best value.
